(19) United States
(12) Patent Application Publication
(10) Pub. No.: US 2009/0005015 A1
(43) Pub. Date: Jan. 1, 2009

(54) Method and Apparatus for Providing IMS Services

(76) Inventors: John H. Shamilian, Tinton Falls, NJ (US); Thomas L. Wood, Colts Neck, NJ (US)

Correspondence Address: PATTERSON & SHERIDAN, LLP/;LUCENT TECHNOLOGIES, INC, 595 SHREWSBURY AVENUE, SHREWSBURY, NJ, 07702, US

(21) Appl. No.: 11/770,473

(22) Filed: Jun. 28, 2007

(51) Int. Cl. H04M 3/42

(52) U.S. Cl. 455/414.1

(57) ABSTRACT

The invention includes a method and apparatus for providing IMS service at the customer premises independent of the core IMS network. A method includes receiving, at a premises gateway to a core IMS network, a request for a service normally provided by the core IMS network, and, in response to a determination that the requested service is capable of being provided locally by the premises gateway, providing the requested service locally at the premises gateway independent of the core IMS network.

### FIELD OF THE INVENTION

The invention relates to the field of communication networks and, more specifically, to services in Internet Protocol (IP) Multimedia Subsystem (IMS) networks.

### BACKGROUND OF THE INVENTION

Internet Protocol (IP) Multimedia Subsystem (IMS) is an architectural framework for delivering IP multimedia services to end users. For example, IMS networks may deliver services such as voice services (e.g., VoIP service, push-to-talk service, and the like), data services, video services, and the like. In existing IMS architectures, IMS systems are located in the core network, and all IMS services are provided from the core IMS network. While this IMS architecture enables easy deployment of services by service providers, end users are prevented from accessing IMS services during core IMS network outages.

### SUMMARY OF THE INVENTION

Various deficiencies in the prior art are addressed through the invention of a method and apparatus for providing IMS service at the customer premises independent of the core IMS network. A method includes receiving, at a premises gateway to a core IMS network, a request for a service normally provided by the core IMS network, and, in response to a determination that the requested service is capable of being provided locally by the premises gateway, providing the requested service locally at the premises gateway independent of the core IMS network.

### BRIEF DESCRIPTION OF THE DRAWINGS

The teachings of the present invention can be readily understood by considering the following detailed description in conjunction with the accompanying drawings, in which:

FIG. 1 depicts high-level block diagram of a communication network;

FIG. 2 depicts a method according to one embodiment of the present invention; and

FIG. 3 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION OF THE INVENTION

The present invention enables at least some of the services that are typically provided to end users by the core IMS network to be provided to end users by associated premises gateways. By adapting premises gateways to support some of the services typically available only from the core IMS network, the present invention offloads some services traffic from the core IMS network (thereby conserving core IMS network resources), and, further, enables some services to continue to be provided to the end users by the premises gateway serving the end users even when those services could not otherwise be provided to the end users from the core IMS network (e.g., due to a service disruption, a network outage, or any other conditions resulting in service disruption to end users). In other words, the present invention extends the IMS network to the customer premise.

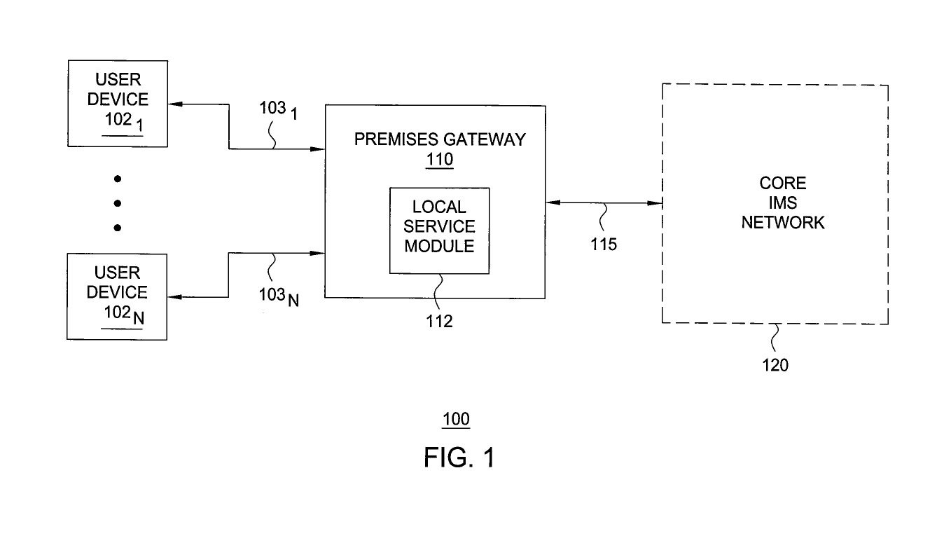

FIG. 1 depicts a high-level block diagram of a communication network. Specifically, communication network 100 includes a plurality of user devices (UDs) 102₁-102_{N} (collectively, UDs 102), a premises gateway (PG) 110, and a core network (CN) 120. The UTs 102₁-102_{N} communicate with PG 110 using respective communication paths (CPs) 103₁-103_{N} (collectively, CPs 103). The PG 110 communicates with CN 120 using a communication path (CP) 115. The UDs 102 include user terminals which may be communicatively coupled to PG 110. The PG 110 functions as an access point by which UDs 102 access CN 120. The CN 120 is an IMS-based network supporting IMS functions and services.

The CN 120 provides IMS functions, such as transport functions, control functions (e.g., connection control functions, session control functions, and the like), applications functions, services functions, and the like, as well as various combinations thereof. The CN 120 may include gateways to circuit-switched and packet-switched networks (including access and core networks), such as access network gateways, border gateways, media gateways, signaling gateways, and the like. The CN 120 may include control functions, such as call-session control functions (e.g., proxy-CSCFs, serving-CSCFs, interrogating-CSCFs), media gateway control functions (MGCFs), breakout gateway control functions (BGCFs), policy decision functions (PDFs), and the like. The CN 120 may provide applications/services, such as home subscriber servers (HSSs), media servers, application servers, and the like. CN 120 may support fewer or more such IMS functions and services.

The CN 120 supports IP multimedia services, such as voice services, data services, video services, multimedia services, and the like, as well as various combinations thereof. For example, CN 120 may support services such as voice calls, voice conferencing, video calls, video conferencing, streaming video, presence services, instant messaging, unified messaging (e.g., voicemail, email, fax, and the like), multimedia calls, multimedia conferencing, multimedia advertising, multiparty gaming, push services (e.g., push-to-talk, push-to-view, push-to-video, and the like), IPTV, intercom services, interactive voice response, group management services, account management services (e.g., for user profiles, payments, and the like), and the like, as well as various combinations thereof.

The CN 120 supports interfaces to other networks, such as circuit switched networks (e.g., the Public Switched Telephone Network (PSTN), Public Land Mobile Networks (PLMNs), and the like), packet switching networks (e.g., IPv4 networks, IPv6 networks, and the like), various third-party networks, and the like as well as various combinations thereof. The interfaces to such other networks may be supported using different gateways. For example, signaling gateways (SGWs) and media gateways (MGWs) may provide interfaces between the IMS-based core network and PSTN/PLMN networks, and border gateways (BGs) may provide interfaces between the IMS-based core network and packet switching networks (e.g., IPv4 networks, IPv6 networks, and the like).

The CN 120 supports numerous different access networks. Thus, CP 115 may be supported using access network technology adapted for interfacing with CN 120. For example, CP 115 may be supported using fixed access networks (e.g., an Ethernets, cable networks, Digital Subscriber Line (DSL) networks, and the like), mobile access networks (e.g., Global System for Mobile (GSM) networks, General Packet Radio Service (GPRS) networks, Code Division Multiple Access—2000 (CDMA2000) networks, Wideband—CDMA (WCDMA) networks, and the like), wireless access networks (e.g., wireless local area networks (WLANs), Worldwide Interoperability for Microwave Access (WiMAX) networks, and the like), and the like, as well as various combinations thereof.

The PG 110 functions as an access gateway by which UTs 102 access CN 120. The PG 110 is deployed at a customer location, e.g., a residential location, a business location, an enterprise location, and the like. For example, PG 110 may be a router, a gateway, an IPBX, and the like. The PG 110 is adapted to support one or more IMS services (i.e., services typically provided by the core IMS network) locally, thereby requiring a distinction between local IMS services and network IMS services. A local IMS service is an IMS service capable of being provided by PG 110 independent of CN 120 (although the service may also be available from the core IMS network). A network IMS service is an IMS service not capable of being provided by PG 110 independent of CN 120 (i.e., the IMS service requires some interaction with CN 120).

For example, local IMS services may include an intercom service (e.g., where one user using a UD 102 connected to PG 110 is able to talk over an intercom with another user using another UD 102 connected to PG 110), a local voice connection (e.g., a push-to-talk service whereby one user using a UD 102 connected to PG 110 is able to talk with another user using another UD 102 connected to PG 110, in a manner similar to using walkie-talkies), a local messaging session (e.g., an instant messaging service whereby one user using a UD 102 connected to PG 110 is able to chat with another user using another UD 102 connected to PG 110), and like services capable of being performed by PG 110 independent of CN 120. The local IMS services supported by PG 110 depend on the service logic configured on PG 110.

For example, network IMS services may include a connection or session between a UD 102 served by PG 110 and another user device served by a different premises gateway (e.g., a voice call, a video call, an instant messaging session, a gaming service, and the like, as well as various combinations thereof), a request to retrieve information stored in the core IMS network (e.g., requests to receive audio clips, video clips, streaming IPTV service, and the like, as well as various combinations thereof), a request to initiate a transaction with one or more components of the core IMS network (e.g., requests to update user profiles, requests to initiate online payments, and the like, as well as various combinations thereof), and the like. The network IMS services may be any services capable of being provided by a core IMS network.

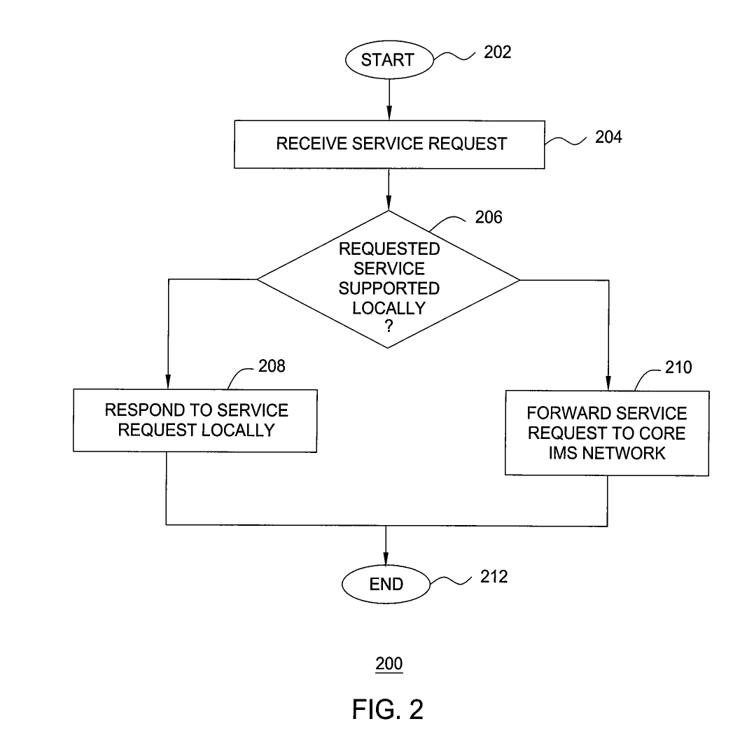

As depicted in FIG. 1, PG 110 supports local IMS services using a local service module 112 operable for providing one or more IMS services locally. The service logic for performing IMS services locally may be preconfigured in PG 110, or may be downloaded into PG 110 (e.g., by the network operator, by service providers, and the like). The PG 110 receives service requests from UDs 102, which may include requests for local IMS services or requests for network IMS services. The PG 110 distinguishes between requests for local IMS services and requests for network IMS services, serving requests for local IMS services locally and forwarding requests for network IMS services to CN 120. The operation of PG 110 in providing local IMS services to UDs 102 may be better understood with respect to FIG. 2.

FIG. 2 depicts a method according to one embodiment of the present invention. Specifically, method 200 of FIG. 2 includes a method for providing an IMS service locally (i.e., a method by which a premises gateway provides an IMS service, that is typically provided by a core IMS network, independent of the core IMS network). Although depicted and described as being performed serially, at least a portion of the steps of method 200 of FIG. 2 may be performed contemporaneously, or in a different order than depicted and described with respect to FIG. 2. The method 200 begins at step 202 and proceeds to step 204.

At step 204, a premises gateway receives a service request from one of the user devices served by the premises gateway. The request may be a request for an IMS service. At step 206, a determination is made as to whether the requested service is supported locally. In other words, a determination is made as to whether the requested service can be provided by the premises gateway independent of the core IMS network (i.e., the requested service does not request any interaction with the core IMS network), or whether the requested service does require some interaction with the core IMS network. If the requested service is supported locally, method 200 proceeds to step 208. If the requested service is not supported locally, method 200 proceeds to step 210.

At step 208, where the requested service is supported locally, the premises gateway responds to the service locally. In one embodiment, the premises gateway may retrieve and execute some service logic (stored locally on the premises gateway) required to provide the requested service. The response provided by the premises gateway depends on the type of service requested. For example, where the requested service is a request to control a television that is initiated from a computer, the premises gateway may execute service logic to provide one or more control signals to the television based upon the action(s) requested from the computer. From step 208, method 200 proceeds to step 212.

At step 210, where the requested service is not supported locally, the premises gateway forwards the service request to the core IMS network. The premises gateway may receive one or more response messages from the core IMS network in response to the service request, which may depend on the type of service requested. For example, the premises gateway may receive streaming video where the service request is a request to view a video clip, the premises gateway may receive ringback where the service request is a request to establish a voice call to another user device, and the like. In such examples, the premises gateway forwards the service responses to the user device for which the service response is intended. From step 210, method 200 proceeds to step 212.

At step 212, method 200 ends. Although depicted and described as ending (for purposes of clarity), premises gateway continues to perform method 200 after handling the service request from the user device (i.e., the premises gateway continues to receive service requests from user devices served by the premises gateway, to evaluate the service requests in order to determine whether the service requests are requests for local IMS services or network IMS services, and to respond to the received service requests accordingly).

Although omitted for purposes of clarity, in one embodiment, in which a service request is a request for an IMS service which is available both from the premises gateway and from the core IMS network, the premises gateway may be adapted to determine whether to serve the service request locally or to forward the service request to the IMS network.

In one embodiment, the determination as to whether to serve the service request locally or to forward the service request to the IMS network may be made based on the type of service requested. For example, for each IMS service available from both the premises gateway and the core IMS network, the premises gateway may be configured to handle associated service requests according to default settings. For example, one type of service may be set such that the service is provided locally by default and is only provided by the core IMS network if the premises gateway cannot provide that service locally, while another type of service may be set such that the service is forwarded to the core IMS network by default and is only provided by the premises gateway if the premises gateway identifies a condition which overrides the default setting.

In one embodiment, where the premises gateway has a choice between serving a service request locally or forwarding the service request to the core IMS network, and an initial determination is made to serve the request locally, the premises gateway may be adapted to forward the request to the core IMS network in response to a detected local condition. The local condition may be a determination that there is an error associated with the service logic stored on the premises gateway that must be executed by the premises gateway in order to provide the requested service locally. The local condition may be a determination that the service request can be served by the core IMS network with a higher quality of service than is currently available from premises gateway (e.g., the premises gateway is overloaded). In other words, the local condition may be any condition which may trigger the premises gateway to forward a service request for an IMS service to the core IMS network rather than provide the IMS service locally.

In one embodiment, where the premises gateway has a choice between serving a service request locally or forwarding the service request to the core IMS network, and an initial determination is made to forward the service request to the core IMS network, the premises gateway may be adapted to serve the service request locally in response to a detected network condition. The network condition may be a determination that the service request cannot be served by the core IMS network (e.g., the access network is unavailable, there is a failure in the core IMS network, the requested service is temporarily unavailable from the core IMS network, and the like). The network condition may be a determination that the service request can be served locally by the premises gateway with a higher quality of service than is currently available from the core IMS network (e.g., there is congestion in the access network, there is congestion in the core IMS network, and the like). In other words, the network condition may be any condition which may trigger the premises gateway to provide an IMS service locally rather than forwarding a service request to the core IMS network.

As described herein, the present invention enables IMS services that were previously only available from the core IMS network to be provided to user devices locally (i.e., the IMS services are provided by the premises gateway without requiring any interaction with the core IMS network). Thus, by providing some IMS services locally the present invention increases the quality of service experienced by all end users, i.e., by end users requesting local IMS services (by increasing service response times because the local IMS services don't require messages to traverse access networks or the core IMS network), as well as by end users requesting network IMS services (by reducing the traffic traversing the core IMS network, thereby freeing up core IMS network resources which may be used to provide IMS services that are only available from the core IMS network).

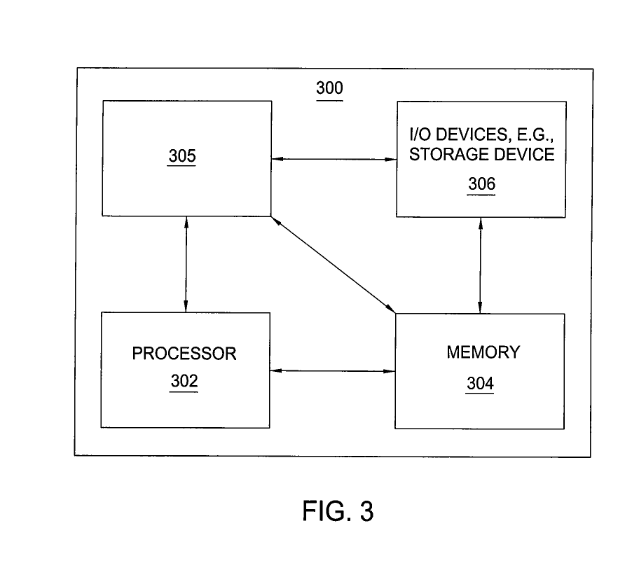

FIG. 3 depicts a high-level block diagram of a general-purpose computer suitable for use in performing the functions described herein. As depicted in FIG. 3, system 300 comprises a processor element 302 (e.g., a CPU), a memory 304, e.g., random access memory (RAM) and/or read only memory (ROM), a local service module 305, and various input/output devices 306 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It should be noted that the present invention may be implemented in software and/or in a combination of software and hardware, e.g., using application specific integrated circuits (ASIC), a general purpose computer or any other hardware equivalents. In one embodiment, the present local service process 305 can be loaded into memory 304 and executed by processor 302 to implement the functions as discussed above. As such, local service process 305 (including associated data structures) of the present invention can be stored on a computer readable medium or carrier, e.g., RAM memory, magnetic or optical drive or diskette, and the like.

Although primarily depicted and described herein with respect to providing IMS services typically available from a core IMS network locally at a premises gateway, the present invention may be used to provide various other types of services typically available from various other types of networks locally at various other equipment. Therefore, the present invention is not intended to be limited to the IMS services described herein, to the communication network architecture depicted and described herein, or, more generally, to IMS networks.

It is contemplated that some of the steps discussed herein as software methods may be implemented within hardware, for example, as circuitry that cooperates with the processor to perform various method steps. Portions of the present invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a broadcast or other signal bearing medium, and/or stored within a working memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method, comprising:
receiving, at a premises gateway to a core IMS network, a request for a service normally provided by the core IMS network; and
in response to a determination that the requested service is capable of being provided locally by the premises gateway, providing the requested service locally at the premises gateway independent of the core IMS network.

2. The method of claim 1, wherein the service request is received from a first user device served by the premises gateway.

3. The method of claim 2, wherein the service request is a request for a service requiring interaction with by the premises gateway with a second user device served by the premises gateway.

4. The method of claim 1, wherein providing the requested service locally at the premise gateway comprises:
retrieving, from a memory of the premise gateway, service logic adapted for providing the requested service; and
executing the service logic at the premises gateway to provide the requested service.

5. The method of claim 1, wherein the determination as to whether the requested service is available at the premises gateway depends on the service that is requested.

6. The method of claim 1, further comprising:
receiving service logic from the core IMS network; and
storing the received service logic.

7. The method of claim 1, wherein the requested service comprises at least one of a voice service, a data service, a video service, a multimedia service, an instant messaging service, an intercom service, and a home appliance control service.

8. An apparatus, comprising:
means for receiving, at a premises gateway to a core IMS network, a request for a service normally provided by the core IMS network; and
means for providing the requested service locally at the premises gateway independent of the core IMS network in response to a determination that the requested service is capable of being provided locally by the premises gateway.

9. The apparatus of claim 8, wherein the service request is received from a first user device served by the premises gateway.

10. The apparatus of claim 9, wherein the service request is a request for a service requiring interaction with by the premises gateway with a second user device served by the premises gateway.

11. The apparatus of claim 9, wherein the means for providing the requested service locally at the premise gateway comprises:
means for retrieving, from a memory of the premise gateway, service logic adapted for providing the requested service; and
means for executing the service logic at the premises gateway to provide the requested service.

12. The apparatus of claim 9, wherein the determination as to whether the requested service is available at the premises gateway depends on the service that is requested.

13. The apparatus of claim 9, further comprising:
means for receiving service logic from the core IMS network; and
means for storing the received service logic.

14. The apparatus of claim 9, wherein the requested service comprises at least one of a voice service, a data service, a video service, a multimedia service, an instant messaging service, an intercom service, and a home appliance control service.

15. A computer readable medium storing a software program that, when executed by a computer, causes the computer to perform a method, comprising:
receiving, at a premises gateway to a core IMS network, a request for a service normally provided by the core IMS network; and
in response to a determination that the requested service is capable of being provided locally by the premises gateway, providing the requested service locally at the premises gateway independent of the core IMS network.

16. The computer readable medium of claim 15, wherein the service request is received from a first user device served by the premises gateway.

17. The computer readable medium of claim 16, wherein the service request is a request for a service requiring interaction with by the premises gateway with a second user device served by the premises gateway.

18. The computer readable medium of claim 15, wherein providing the requested service locally at the premise gateway comprises:
retrieving, from a memory of the premise gateway, service logic adapted for providing the requested service; and
executing the service logic at the premises gateway to provide the requested service.

19. The computer readable medium of claim 15, wherein the determination as to whether the requested service is available at the premises gateway depends on the service that is requested.

20. The computer readable medium of claim 15, further comprising:
receiving service logic from the core IMS network; and
storing the received service logic.
